(19) United States
(12) Patent Application Publication
(10) Pub. No.: US 2023/0129388 A1
(43) Pub. Date: Apr. 27, 2023

(54) PATH SWITCH WITH SERVICE CONTINUITY IN A LAYER-2 UE-TO-NETWORK RELAY

(71) Applicant: MediaTek Singapore Pte. Ltd., Singapore (SG)

(72) Inventors: Nathan Edward Tenny, San Jose, CA (US); Xuelong Wang, Beijing (CN)

(21) Appl. No.: 17/969,525

(22) Filed: Oct. 19, 2022

Related U.S. Application Data
(63) Continuation of application No. PCT/CN2021/125682, filed on Oct. 22, 2021.

(30) Foreign Application Priority Data
Oct. 13, 2022 (CN) 202211257989.5

(51) Int. Cl. H04W 24/10; H04W 76/30; H04W 36/00

(52) U.S. Cl. CPC H04W 24/10; H04W 76/30; H04W 36/0016; H04W 92/18

(57) ABSTRACT

An indirect-to-indirect path switching procedure is proposed for transferring operation of a remote user equipment (UE) from a first relay UE to a second relay UE, while preserving continuity of the user's service(s) offered by a cellular network through the first and second relay UEs, in a layer 2 UE-to-network relaying architecture.

### CROSS REFERENCE TO RELATED APPLICATIONS

This application is filed under 35 U.S.C. § 111(a) and is based on and hereby claims priority under 35 U.S.C. § 120 and § 365 (c) from international application No. PCT/CN2021/125682, entitled “Indirect-to-indirect path switch with service continuity in a layer 2 UE-to-Network relay,” filed on Oct. 22, 2021. This application claims priority under 35 U.S.C. § 119 from Chinese application 202211257989.5 filed on Oct. 13, 2022. The disclosure of each of the foregoing documents is incorporated herein by reference.

### TECHNICAL FIELD

The disclosed embodiments relate generally to wireless network communications, and, more particularly, to path switch in a layer 2 UE-to-Network relay in 5G new radio (NR) wireless communications systems.

### BACKGROUND

In a UE-to-network relaying environment, a so-called “remote UE” receives service from a cellular network via an intermediary “relay UE”, using a sidelink interface (for example, a PC5 interface in 3GPP systems) for communication between the remote UE and the relay UE. The protocol stacks between the two UEs and the network may be structured in various ways. If a “layer 2” relay architecture is considered, then the relaying relationship is mediated by an adaptation layer that functions as a sublayer of layer 2 of a protocol stack, e.g., located between the RLC and PDCP layers.

A UE may operate in direct communication with a network node such as a base station (gNodeB or gNB) while in coverage, referred to as a “direct path” service. Alternatively, a UE may function as a remote UE in a UE-to-network relaying relationship, obtaining service from the network via communicating directly with a relay UE, which then communicates directly with a gNB, referred to as an “indirect path” service. A remote UE may be in or out of network coverage. When the remote UE is in network coverage, it may experience poor link conditions that degrade its service quality on the direct path, and therefore it may prefer to operate on an indirect path through a relay UE. In a “single-hop” relaying environment, where only one relay UE is permitted to operate between a remote UE and the cellular network, the relay UE is in network coverage by definition. However, in a “multi-hop” relaying environment, where one relay UE may communicate with another relay UE rather than directly with the network, some relay UEs may also be out of network coverage. A setting where at least one of the involved UEs (for instance, a remote UE) is out of coverage, while at least one of the involved UEs (for instance, a relay UE) is in coverage, may be referred to as a partial-coverage scenario.

Due to various events such as physical mobility and/or changing radio conditions, a remote UE may initially be served by a first relay UE, and later find that a second relay UE can offer better service. In such a situation, it is advantageous for the remote UE to be able to perform a path switch operation, in which it relocates its service to use the second relay UE instead of the first relay UE. It is naturally preferable for the path switch operation to offer service continuity, i.e., to operate in such a manner that the user service is not interrupted as a result of the path switch.

In a layer 2 UE-to-network relaying environment, it is advantageous for the remote UE to be able to switch its service from operating through a first relay UE to operating through a second relay UE, a process which may be referred to as an indirect-to-indirect path switch. Furthermore, the path switch operation should allow continuity of user services.

### SUMMARY

An indirect-to-indirect path switching procedure is proposed for transferring operation of a remote user equipment (UE) from a first relay UE to a second relay UE, while preserving continuity of the user's service(s) offered by a cellular network through the first and second relay UEs, in a layer 2 UE-to-network relaying architecture.

Other embodiments and advantages are described in the detailed description below. This summary does not purport to define the invention. The invention is defined by the claims.

### BRIEF DESCRIPTION OF THE DRAWINGS

FIG. 1 illustrates a wireless cellular communications system supporting an indirect-to-indirect path switch for a remote user equipment (UE) with service continuity in a layer 2 UE-to-Network relay in accordance with a novel aspect.

FIG. 2 is a simplified block diagram of a wireless transmitting device and a receiving device in accordance with embodiments of the current invention.

FIG. 3 illustrates user plane protocol stacks for a layer 2 relaying architecture for UE-to-network relay in accordance with one novel aspect.

FIG. 4 illustrates a simplified sequence flow of an intra-gNB indirect-to-indirect path switch operation in accordance with one novel aspect.

FIG. 5 illustrates a sequence flow of an inter-gNB indirect-to-indirect path switch operation for all RRC states in accordance with one novel aspect.

FIG. 6 illustrates a sequence flow of an inter-gNB indirect-to-indirect path switch operation with redirection of handover to a new cell after the target relay UE resumes.

FIG. 7 illustrates a sequence flow of an inter-gNB indirect-to-indirect path switch operation with user-plane data handling in accordance with one novel aspect.

FIG. 8 is a flow chart of a method of indirect-to-indirect path switch from a remote UE perspective in accordance with one novel aspect.

FIG. 9 is a flow chart of a method of indirect-to-indirect path switch from a source gNB perspective in accordance with one novel aspect.

### DETAILED DESCRIPTION

Reference will now be made in detail to some embodiments of the invention, examples of which are illustrated in the accompanying drawings.

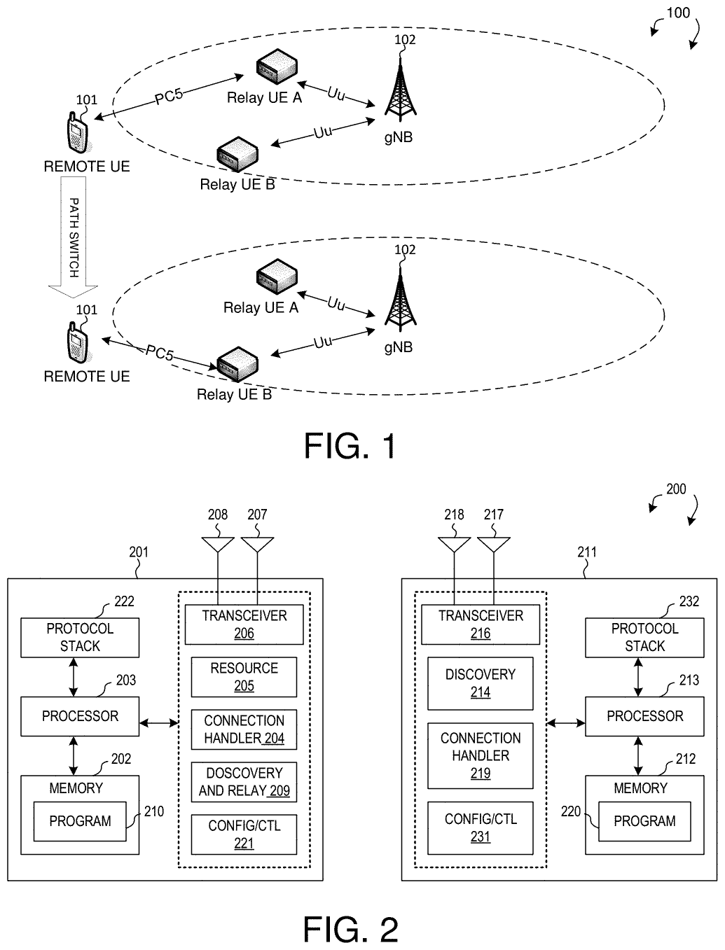

FIG. 1 illustrates a wireless cellular communications system 100 supporting an indirect-to-indirect path switch with service continuity in a layer 2 UE-to-Network relay in accordance with a novel aspect. In a UE-to-network relaying architecture, when a remote UE 101 receives service through a first relay UE A, a variety of events may cause the remote UE to need to switch to a second relay UE B. For example, the first relay UE A may move out of range of the remote UE (or vice versa), the first relay UE A may cease offering relaying service, or the second relay UE B may simply be able to offer better service due to better radio conditions along the indirect path comprising the remote UE 101, the second relay UE B, and a serving network node such as a gNB 102. Accordingly, it is beneficial for a procedure to be available for switching the remote UE's service from the first relay UE A to the second relay UE B, without creating a service interruption for the user.

Such indirect-to-indirect path switch may be construed as a form of handover, in which the source and target are relay UEs, rather than cells/gNBs as in a conventional handover operation. Thus, for instance, the remote UE may be provided with a reconfiguration instruction, such as an RRCReconfiguration message of a radio resource control (RRC) protocol, that defines a configuration for the remote UE to operate with the target relay UE. The reconfiguration instruction may be sent by a serving network node and delivered to the remote UE via the source relay UE.

In the example of FIG. 1, remote UE 101 switches its service path from relay UE A to relay UE B. Like a conventional handover, an indirect-to-indirect path switch may be controlled by the network node (for instance, gNB 102) that initially serves the remote UE 101. In FIG. 1, the two relay UEs are shown as served by the same gNB 102 (intra-gNB case). However, it could also be considered for a remote UE to switch from a first relay UE served by a first gNB to a second relay UE served by a second gNB (inter-gNB case, not shown).

In principle the gNB may trigger the path switch at any time, but under typical circumstances the gNB may be expected to trigger a path switch in response to receiving one or more measurements from the remote UE, with the measurements indicating that the target relay UE can be expected to offer better service than the source relay UE. For example, a measurement report may be triggered based on an event defined by “Candidate relay UE signal strength exceeds serving relay UE signal strength by a threshold”, an event defined by “Serving relay UE signal strength is below a threshold”, an event defined by “Candidate relay UE signal strength is above a threshold”, an event defined by “Serving relay UE signal strength is below a first threshold and candidate relay UE signal strength is above a second threshold”, and so on. The signal strength referred to in the event definitions may be a measure of signal strength on a sidelink interface, also known as a PC5 interface. The “serving” relay UE is synonymous with the source relay UE, and the “candidate” relay UE is synonymous with the target relay UE.

FIG. 2 is a simplified block diagram of wireless devices 201 and 211 in accordance with a novel aspect. For wireless device 201 (e.g., a relay UE), antennae 207 and 208 transmit and receive radio signals. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a remote UE), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a relay UE that includes a protocol stack 222, a resource management circuit 205 for allocating and scheduling sidelink resources, a connection handling circuit 204 for establishing and managing connections, a traffic relay discovery and handling controller 209 for discovering remote UEs and relaying all or part of control signalling and/or data traffic for remote UEs, and a control and configuration circuit 221 for providing control and configuration information. Wireless device 211 is a remote UE that includes a protocol stack 232, a relay discovery circuit 214 for discovering relay UEs, a connection handling circuit 219 for establishing and managing connections, and a configuration and control circuit 231. The different functional modules and circuits can be implemented and configured by software, firmware, hardware, and any combination thereof. The functional modules and circuits, when executed by the processors 203 and 213 (e.g., via executing program codes 210 and 220), allow relay UE 201 and remote UE 211 to perform embodiments of the present invention accordingly.

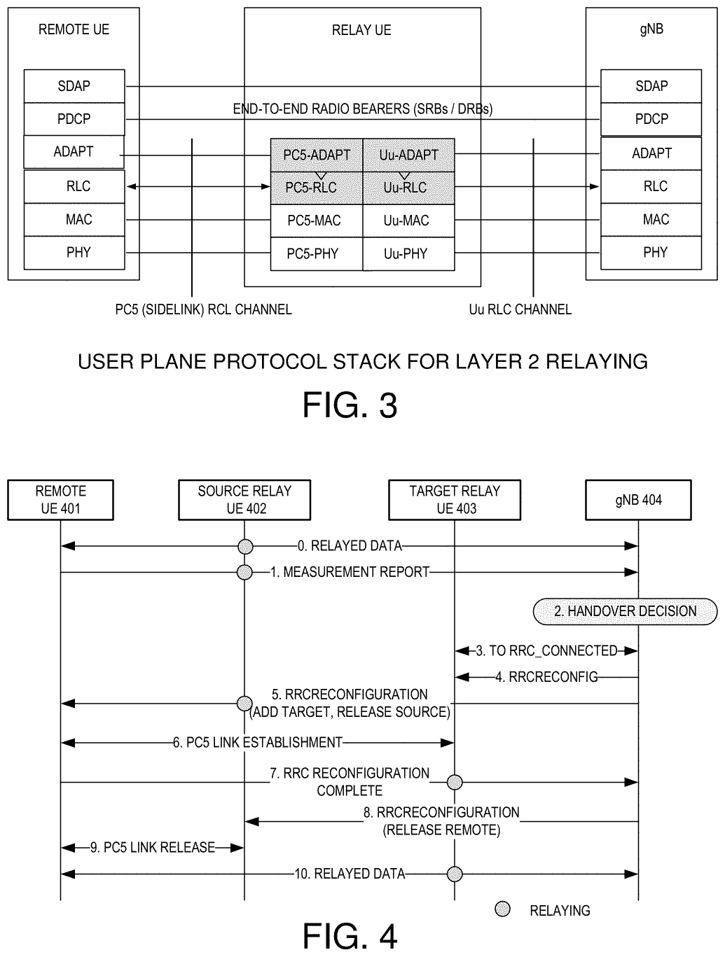

FIG. 3 illustrates user plane protocol stacks for a layer 2 relaying architecture for UE-to-network relay in accordance with one novel aspect. If a layer 2 relay architecture is considered, then the relaying relationship is mediated by an adaptation layer that functions as a sublayer of layer 2 of a protocol stack, e.g., located between the RLC and PDCP layers. In FIG. 3, the illustrated stack comprises a set of access stratum (AS) protocol layers, including a service data adaptation protocol (SDAP) layer terminated between a remote UE and a gNB, a packet data convergence protocol (PDCP) layer terminated between the remote UE and the gNB, a PC5 adaptation (PC5-ADAPT) layer terminated between the remote UE and a relay UE, a Uu adaptation (Uu-ADAPT) layer terminated between the relay UE and the gNB, and lower layers terminated separately between the remote UE and the relay UE, and between the relay UE and the gNB. The lower layers on each interface as shown in the figure comprise a radio link control (RLC) layer, a medium access control (MAC) layer, and a physical (PHY) layer, over each of a sidelink interface and a Uu interface. One or both of the PC5 and Uu adaptation layers may also be referred to as a sidelink adaptation layer protocol (SALP) layer or as a sidelink adaptation protocol (SLAP) layer, which may also be referred to as a sidelink relay adaptation protocol (SRAP) layer.

A layer 2 UE-to-network relaying architecture is well positioned to offer an “indirect-to-indirect” path switch procedure. In a layer 2 architecture, the upper layers of the protocol stack—for instance, an internet protocol (IP) layer, an SDAP layer, and/or a PDCP layer—terminate between the remote UE and nodes of the network. This means that the state of these upper layers (for example, an IP address of the remote UE) can be maintained even as the remote UE's data path switches between different relay UEs, making service continuity feasible without requiring special behaviour from the upper layers, such as handling mechanisms in the application layer to deal with changing IP addresses.

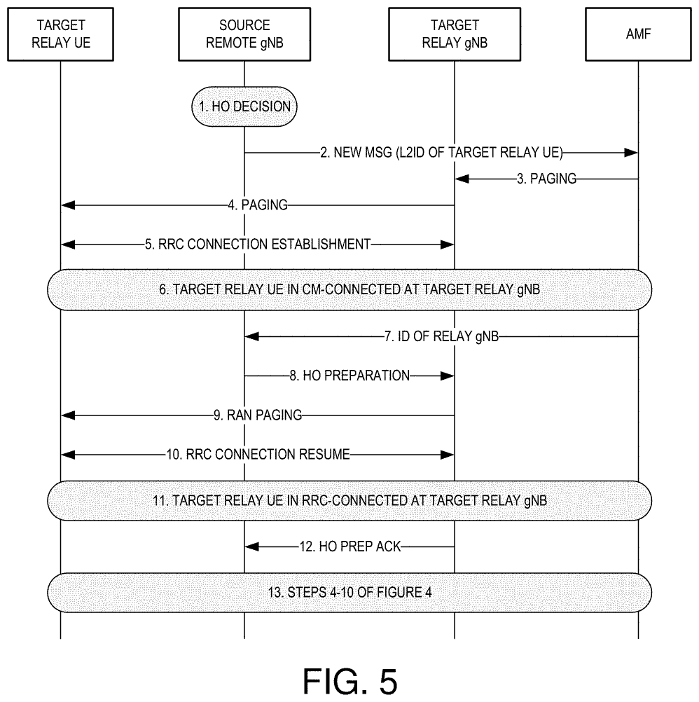

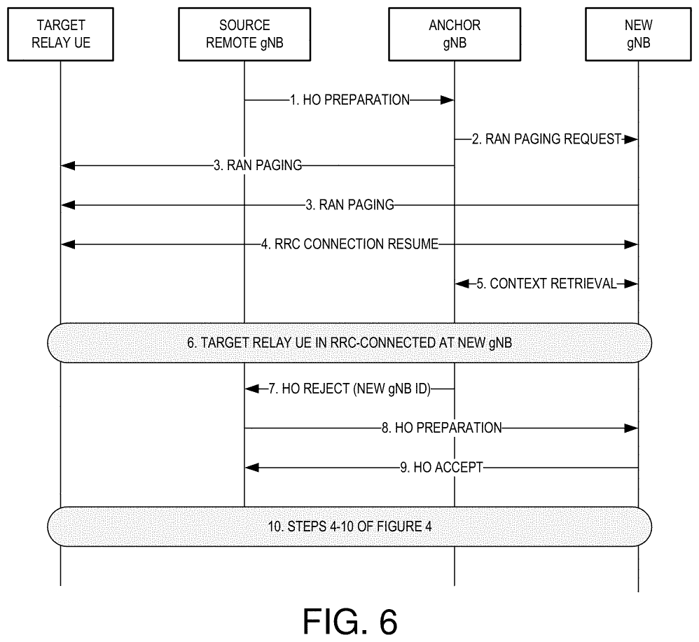

FIG. 4 illustrates a simplified sequence flow of an intra-gNB indirect-to-indirect path switch operation in accordance with one novel aspect. In step 0, data are being relayed between a remote UE 401 and a gNB 404 via a source relay UE 402. In step 1, remote UE 401 sends to gNB 404, via source relay UE 402, a measurement report. The measurement report may indicate radio conditions that make a target relay UE 403 a better candidate for offering service than source relay UE 402, for instance, due to a set of event criteria being met, as described above. The measurement report may comprise one or more sets of measurements of sidelink signal strength and/or sidelink signal quality, corresponding to measurements taken by the remote UE 401 on sidelink communications with the source relay UE 402, the target relay UE 403, or both. The measurement report may additionally comprise cell related measurements.

In step 2, the gNB makes the decision to trigger the path switch operation. This decision may be based on criteria specific to the gNB implementation. In step 3, the gNB brings the target relay UE to a connected state (for instance, an RRC_CONNECTED state of an RRC protocol). It is noted that the source relay UE may already be in a connected state, due to needing a connection with the gNB to transmit the relayed measurement report at step 1, and thus there is no need to bring the source relay UE to a connected state. However, the target relay UE may initially be in any protocol state, including, for example, an RRC_INACTIVE state of an RRC protocol or an RRC_IDLE state of an RRC protocol.

In step 4, the gNB sends a first reconfiguration instruction (for example, an RRCReconfiguration message of an RRC protocol) to the target relay UE, configuring the target relay UE to communicate on a sidelink interface with the remote UE. The first reconfiguration instruction may, for instance, contain configurations for one or more protocol layers for communication on the sidelink interface with the remote UE, such as a PHY layer, a MAC layer, an RLC layer, and/or a SALP or SLAP layer (i.e., PC5-ADAPT layer). The first reconfiguration instruction may also, for instance, contain configurations for one or more protocol layers for communication on a Uu interface between the target relay UE and the gNB, such as a PHY layer, a MAC layer, an RLC layer, and/or a SALP or SLAP layer (i.e., Uu-ADAPT layer).

In step 5, the gNB sends, via the source relay UE, a second reconfiguration instruction (for example, an RRCReconfiguration message of an RRC protocol) to the remote UE, configuring the remote UE to stop communication with the source relay UE and to start communication with the target relay UE. In some embodiments, step 5 may be realised by two separate reconfiguration instructions, such as a first RRCReconfiguration message instructing the remote UE to start communication with the target relay UE and a second RRCReconfiguration message instructing the remote UE to stop communication with the source relay UE. In other embodiments, step 5 may be realised by a single reconfiguration instruction.

In step 6, the remote UE and the target relay UE establish a link on the sidelink interface (for example, a PC5 link on a PC5 interface). It is noted that step 6 may not be necessary, if, for example, the remote UE and the target relay UE are already exchanging sidelink communication for other purposes besides relaying. However, even in such a case, the remote UE and the target relay UE may still opt to establish a separate link for the purpose of relaying. The details of step 6 may follow procedures in the existing art for the establishment of a PC5 link, including, for example, the exchange of a sequence of messages of a PC5 signalling (PC5-S) protocol to establish the link, the transmission of an RRCReconfigurationSidelink message of a PC5 radio resource control (PC5-RRC) protocol to configure the PC5 protocol layers between the remote UE and the target relay UE, and so on.

In step 7, the remote UE transmits, via the target relay UE, a handover complete indication (for example, an RRCReconfigurationComplete message of an RRC protocol) to the gNB. At this point, the “handover” portion of the path switch has completed, and the gNB is aware that the remote UE can be served through the target relay UE. In step 8, the gNB sends to the source relay a third reconfiguration instruction (for example, an RRCReconfiguration message of an RRC protocol), configuring the source relay UE to release its configuration for communication with the remote UE. The third reconfiguration instruction may, for instance, contain release indications for one or more protocol layers on the sidelink interface between the source relay UE and the remote UE. A release indication for a protocol layer may take the form of the absence of a configuration for the protocol layer, an explicit release instruction, and so on.

In step 9, the source relay UE and the remote UE exchange signalling to release their link on the sidelink interface (for example, a PC5 link on a PC5 interface). The details of step 9 may follow procedures in the existing art for the release of a PC5 link, including, for example, the exchange of a sequence of messages of a PC5-S protocol to release the link, the transmission of an RRCReconfigurationSidelink message of a PC5-RRC protocol to release the PC5 protocol layers between the remote UE and the source relay UE, and so on. In step 10, relayed data are transmitted between the remote UE and the gNB via the target relay UE.

It is noted that not all steps of FIG. 4 must take place in the order shown. For example, step 10 may take place immediately after step 7, and steps 8 and 9 may be delayed, without substantially affecting the path switch procedure. Furthermore, step 1 may be omitted or replaced by other triggering events if there are other criteria for the gNB to trigger an indirect-to-indirect path switch. For example, a gNB might perform load balancing between the relay UEs that it serves, resulting in reallocation of remote UEs from one relay UE to another even though radio conditions do not require such a reallocation.

FIG. 4 only describes the “intra-gNB” case, in which the source and target relay UEs are served by the same gNB. Furthermore, FIG. 4 simplifies the state transition in step 3 into a single event, subsuming the details of triggering the state transition for the target relay UE. It is noted that FIG. 4 may be applicable in a system where the remote UE is only allowed to switch to a relay UE within the current serving cell. Such a constraint could be enforced at the remote UE side, with a requirement that the remote UE only reports candidate relay UEs that are served by the same cell (or, alternatively, the same gNB, as discussed below). This requirement can be enabled by having the relay UEs indicate their serving cells/gNBs for the benefit of remote UEs that may be measuring them, for example, as part of a discovery signalling message.

Alternatively, the “same cell” (or “same gNB”) constraint can be enforced by the network, i.e., the serving gNB may trigger a path switch operation to a particular target relay UE only if the target relay UE has the same serving gNB as the source relay UE. If the relay UE is in RRC_CONNECTED, it is obvious whether it has the same serving gNB, but in RRC_INACTIVE or RRC_IDLE, a candidate relay UE may perform cell reselection to a different cell at any time, and may thus be served by a different gNB, unknown to the remote UE's serving gNB. The necessary information on the relay UE's serving gNB can be made available to the remote UE's serving gNB with specific operating constraints on the system: the relay UE is always maintained in RRC_CONNECTED (and in this case step 3 of FIG. 4 is not needed); or the relay UE may be in RRC_CONNECTED or RRC_INACTIVE, but when in RRC_INACTIVE, the relay UE is configured to interact with the network (for example, to perform a RAN notification area update procedure) if it reselects out of the current serving cell; or the relay UE may be in any of RRC_CONNECTED, RRC_INACTIVE, or RRC_IDLE, but when in RRC_INACTIVE or RRC_IDLE, the relay UE is configured to interact with the network if it reselects out of the current serving cell. This interaction may take the form of a RAN notification area update in RRC_INACTIVE, and a tracking area update in RRC_IDLE. Any of these constraints would allow the system to ensure that the relay UE is reachable by the current serving cell.

With respect to the relationship between “same serving cell” and “same serving gNB” criteria, if the serving gNB maintains more than one cell, it can make the stored RRC contexts of the remote and/or relay UEs available to all the cells of the serving gNB. Thus, the intra-gNB flow of FIG. 4 can be applied to an inter-cell path switch (that is, a path switch in which the source relay UE is served by a first cell while the target relay UE is served by a second, different cell). Such intra-gNB but inter-cell cases can readily be distinguished by the gNB itself, since the gNB knows which cells it operates. However, if the remote UE is responsible for enforcing an intra-gNB criterion (e.g., if the remote UE is expected to report only relay UEs served by cells of the same gNB that serves the remote UE), then the remote UE may need to be made aware of which cells belong to which gNBs. This information may, for instance, be made available in the form of a serving gNB ID indicated by each relay UE in discovery signalling, allowing the remote UE to know the gNB that serves a candidate relay UE when the remote UE discovers the candidate relay UE. The remote UE would also need to know the gNB ID of the gNB that serves the remote UE itself (via the source relay UE), which could be available from the serving cell's system information, indicated by the source relay UE, and so on.

FIG. 5 illustrates a sequence flow of an inter-gNB indirect-to-indirect path switch operation for all RRC states in accordance with one novel aspect. FIG. 5 extends upon FIG. 4 by addressing the limitation to operation within a single serving gNB, showing salient portions of the inter-gNB indirect-to-indirect path switch procedure for all RRC states. The two gNBs are described in FIG. 5 as the “remote gNB” (the gNB initially serving the remote UE, which inherently is also the gNB serving the source relay UE, since the remote UE obtains its network service through the source relay UE), and the “relay gNB” (the gNB serving the target relay UE, which is also the gNB finally serving the remote UE at the end of the procedure, since the remote UE then obtains its network service through the target relay UE).

In step 1 of FIG. 5, the remote gNB takes a handover decision, which may be triggered by criteria specific to the remote gNB implementation. In step 2, the remote gNB queries an access and mobility management function (AMF) to determine the identity of the relay gNB, that is, the location of the target relay UE within the network. Step 2 may be necessary because the remote gNB does not maintain knowledge of the location or service status of UEs in the network other than those served by the remote gNB itself, and thus may not be expected to know the location of the target relay UE. The query message in step 2 may be a new message of an NG application protocol (NGAP). It is noted that the query message may rely on non-UE-associated signalling, since the AMF and the remote gNB do not have a signalling association related to the target relay UE. The query message may contain an AS identifier of the target relay UE, such as a layer 2 ID (L2ID). The identifier of the target relay UE may be reported to the remote gNB, for example, in a measurement report sent by the remote UE (not shown in FIG. 5). When the AMF receives the query in step 2, it identifies the target relay UE by a core network (CN) identifier such as a 5G S-Temporary Mobile Subscription Identifier (5G-S-TMSI); this implies that the AMF must maintain a mapping of AS identifiers of relay UEs and CN identifiers of relay UEs. The maintenance of this mapping is outside the scope of this invention.

Based on identifying the target relay UE by a CN identifier, the AMF determines the connection management state of the target relay UE. If the target relay UE is in a connected connection management state (for example, a CM-CONNECTED state), steps 3-5 may be skipped. If the target relay UE is in an idle connection management state (for example, a CM-IDLE state), steps 3-5 are needed. In step 3, the AMF sends a paging instruction to the relay gNB, and in step 4, the relay gNB transmits a corresponding paging message over the air (for example, a Paging message of an RRC protocol). In step 5, the target relay UE responds to the page by sending a message to the relay gNB. The message may, for instance, comprise a request to establish an RRC connection. After step 5, the relay gNB may forward a message to the AMF indicating that the target relay UE is available, such as a non-access-stratum (NAS) message sent by the target relay UE in association with step 5 (not shown in the figure).

In step 6, the target relay UE may safely be assumed to be in a CM-CONNECTED state at the relay gNB. In step 7, the AMF sends to the remote gNB an indication of the identity of the relay gNB; this indication may be a new NGAP message. The indication may use non-UE-associated signalling. In step 8, the remote gNB begins a handover procedure for the remote UE by sending a handover preparation message to the relay gNB. The handover preparation message may be a message of an Xn application protocol (XnAP). The relay gNB evaluates the RRC protocol state of the target relay UE. If the target relay UE is in an RRC_CONNECTED state, steps 9 and 10 may be skipped. If the target relay UE is in an RRC_INACTIVE state, steps 9 and 10 are needed. In step 9, the relay gNB transmits a RAN paging message over the air (for example, a Paging message of an RRC protocol, in which the target relay UE is identified by an Inactive Radio Network Temporary Identifier (I-RNTI)). In step 10, the target relay UE responds to the RAN paging message, for instance, by requesting resumption of an RRC connection by the relay gNB. Step 10 may comprise multiple messages of an RRC protocol, such as an RRCResumeRequest message from the target relay UE to the relay gNB, an RRCResume message from the relay gNB to the target relay UE, and an RRCResumeComplete message from the target relay UE to the relay gNB (not shown in the figure). This operation may be in accordance with legacy methods of RRC connection resumption.

In step 11, the target relay UE may safely be assumed to be in an RRC_CONNECTED state at the relay gNB. In step 12, the relay gNB accepts the handover that was previously requested by the remote gNB, by sending a handover preparation acknowledgement to the remote gNB. The handover preparation acknowledgement may be an XnAP message. The handover preparation acknowledgement message may also be referred to as a handover accept message.

In step 13, steps 4-10 of FIG. 4 are carried out, with the following differences: The first RRCReconfiguration message (step 4 of FIG. 4) is sent by the relay gNB; The second RRCReconfiguration message (step 5 of FIG. 4) may contain configuration information provided by the relay gNB in the handover preparation acknowledgement; The RRCReconfigurationComplete message (step 7 of FIG. 4) is sent to the relay gNB; The final relayed data (step 10 of FIG. 4) are exchanged between the remote UE and the relay gNB.

FIG. 5 contains an embedded assumption for the case where the target relay UE is initially in RRC_INACTIVE state. The signalling from step 10 onward assumes that the relay gNB shown in the figure is actually the gNB that serves the target relay UE after it resumes from RRC_INACTIVE. However, if the target relay UE was sent to RRC_INACTIVE and subsequently performed a cell reselection to a different cell, it may be served by a new gNB. In this case the “relay gNB” of FIG. 5 can be considered as the anchor gNB of the target relay UE, and the anchor gNB cannot accept the handover that is requested by the remote gNB since the anchor gNB does not actually serve the target relay UE.

FIG. 6 addresses this issue by showing a procedure for directing the handover procedure to the new gNB. FIG. 6 illustrates a sequence flow of an inter-gNB indirect-to-indirect path switch operation with redirection of handover to a new cell after the target relay UE resumes. FIG. 6 begins when the remote gNB requests a handover of the target relay UE to the anchor gNB (the equivalent of step 8 of FIG. 5). In step 1, the remote gNB sends a handover preparation message to the anchor gNB. The anchor gNB, aware that the target relay UE is in RRC_INACTIVE, triggers a RAN paging procedure to locate the target relay UE and bring it to RRC_CONNECTED state. In step 2, the anchor gNB sends a RAN paging request to the new gNB. A similar RAN paging request may be sent to other gNBs in the same RAN notification area (RNA), which are not shown in FIG. 6. In step 3, the gNBs involved in the RAN paging operation (for example, the anchor gNB and the new gNB, as well as potentially other gNBs in the same RNA) send a RAN paging message to the target relay UE over the air. In step 4, the target relay UE detects the RAN paging message and responds to resume its RRC connection at the new gNB. In step 5, the new gNB retrieves the target relay UE's RRC context from the anchor gNB. Step 5 may comprise multiple messages, such as a context transfer request and a context transfer. For example, the multiple messages may be XnAP messages.

In step 6, the target relay UE may safely be assumed to be in RRC_CONNECTED state at the new gNB. In step 7, the anchor gNB rejects the handover that was requested by the remote gNB, providing, along with the rejection indication, an indication of the identity of the new gNB. The indication of the identity of the new gNB may be included in a rejection message. The rejection message may be an XnAP message. In step 8, the remote gNB sends a handover preparation message to request a handover of the remote UE to the new gNB. In step 9, the new gNB, which serves the target relay UE, accepts the handover, potentially providing configuration information that can be used to configure the remote UE for communication with the target relay UE.

Step 10 subsumes steps 4-10 of FIG. 4, with the following changes: The first RRCReconfiguration message (step 4 of FIG. 4) is sent by the new gNB; The second RRCReconfiguration message (step 5 of FIG. 4) may contain configuration information provided by the new gNB in the handover preparation acknowledgement; The RRCReconfigurationComplete message (step 7 of FIG. 4) is sent to the new gNB; The final relayed data (step 10 of FIG. 4) are exchanged between the remote UE and the new gNB.

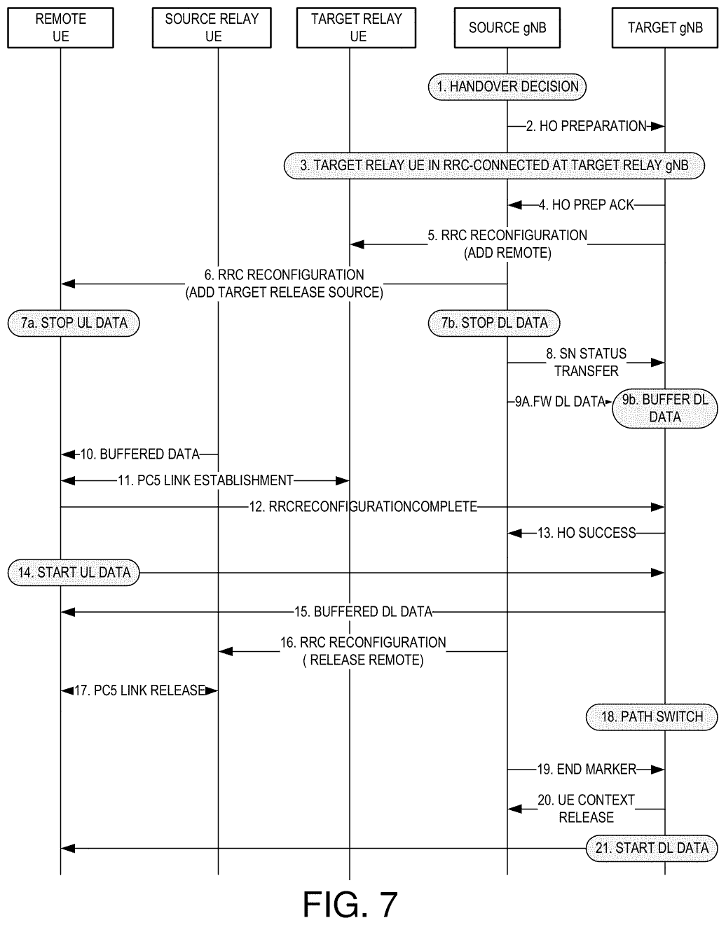

As discussed above, it is preferred that the path switch procedure should offer service continuity to the user, i.e., an existing service should be able to continue uninterrupted. FIG. 7 shows the path switch procedure including the handling of user-plane data. FIG. 7 illustrates a sequence flow of an inter-gNB indirect-to-indirect path switch operation with user-plane data handling in accordance with one novel aspect. In step 1 of FIG. 7, the source gNB takes the decision to perform a handover (i.e., a path switch operation) of the remote UE from the source relay UE (located at the source gNB) to the target relay UE (located at the target gNB). This handover decision may be based upon implementation-specific criteria, but may take into account, for example, measurements reported by the remote UE, as previously discussed. In step 2, the source gNB sends a handover preparation message to prepare the target gNB to receive the context of the remote UE in handover. The handover preparation message may be an XnAP message. In step 3, the target gNB brings the target relay UE to RRC_CONNECTED, if necessary. It is noted that steps 2-4 may subsume the CN paging and/or RAN paging operations that were previously discussed, and the redirection of the handover to a new target gNB as shown in FIG. 6.

In step 5, the target gNB sends to the target relay UE a first reconfiguration command (for example, a first RRCReconfiguration message) instructing the target relay UE to add the remote UE as a served remote. In step 6, the source gNB sends to the remote UE, via the source relay UE, a second reconfiguration command (for example, a second RRCReconfiguration message) instructing the remote UE to add the target relay UE as a serving relay and to remove the source relay UE as a serving relay. It is noted that steps 5 and 6 may take place in any order. In step 7a, the remote UE stops transmitting uplink (UL) data towards the source gNB via the source relay UE, and in step 7b, the source gNB stops transmitting downlink (DL) data towards the remote UE via the source relay UE. However, after steps 7a and 7b, UL data may continue to be generated and buffered at the remote UE, and DL data may continue to arrive from the CN at the source gNB. In step 8, the source gNB sends a sequence number (SN) status transfer message to the target gNB, conveying the status of the PDCP layer at the source gNB when over-the-air data transmission has been stopped; the SN status transfer message may be an XnAP message. The SN status may indicate one or more UL PDCP service data units (SDUs) that the remote UE will need to retransmit to the target gNB, via the target relay UE, when the path switch is completed. In step 9a, the source gNB forwards to the target gNB any DL data that arrives from the CN for the remote UE, and in step 9b, the target gNB buffers any such DL data. In step 10, the source relay UE delivers to the remote UE any remaining buffered DL data (for instance, data that arrived before the reconfiguration command in step 6, but that were not yet delivered successfully to the remote UE). In step 11, the remote UE and the target relay UE establish a PC5 link; this establishment may comprise a procedure for PC5-S link establishment and/or PC5-RRC connection establishment, which may subsume multiple messages whose details are not shown in the figure. It is noted that steps 8-11 may take place in a different order from the order shown in the figure; for instance, the source remote UE may deliver buffered data to the remote UE while the source gNB and the target gNB are carrying out steps 8 and 9a/9b. Steps 9a and 9b may take place on an ongoing basis for as long as DL data continue to arrive at the source gNB.

In step 12, the remote UE sends a handover complete message (for instance, an RRCReconfigurationComplete message) to the target gNB via the target relay UE, signifying that from the remote UE perspective the handover is complete. In step 13, the target gNB sends a handover success message to the source gNB; the handover success message may be an XnAP message. In step 14, the remote UE begins transmitting UL data, via the target relay UE, to the target gNB; this step includes delivering any UL data that were buffered at the remote UE after step 7a. In step 15, the target gNB transmits to the remote UE, via the target relay UE, any DL data that were buffered in step 9b. In step 16, the source gNB transmits to the source relay UE a third reconfiguration command (for instance, a third RRCReconfiguration message), indicating to the source relay UE to release the remote UE. In step 17, the remote UE and the source relay UE perform a PC5 link release procedure; this release may comprise a procedure for PC5-S link release and/or PC5-RRC connection release, which may subsume multiple messages whose details are not shown in the figure. It is noted that steps 16 and 17 may take place asynchronously with respect to steps 14 and 15. In step 18, the target gNB triggers a path switch operation with the CN, causing the user data path for the remote UE to be transferred from the source gNB to the target gNB; the path switch operation may take place in accordance with a legacy handover procedure. In step 19, the source gNB delivers to the target gNB an end marker, indicating that data forwarding from the source gNB to the target gNB has completed. In step 20, the target gNB sends to the source gNB a UE context release message; the UE context release message may be an XnAP message. In step 21, the target gNB begins transmitting DL data to the remote UE via the target relay UE, comprising any data that were received from the source gNB before step 19 as well as any new data arriving from the CN. It is noted that, as a result of the SN status transfer message in step 8, the target gNB is aware of what UL PDCP SDUs are missing (i.e., were not received by the source gNB) and can induce retransmission of the missing UL PDCP SDUs by legacy methods, such as sending a PDCP status report to the remote UE. Thus, the handover/path switch procedure can be lossless with respect to UL data sent by the remote UE. In the DL direction, all DL data delivered from the CN to the source gNB are either forwarded by the source relay UE (step 10) or forwarded to the target gNB (step 9a), buffered at the target gNB (step 9b), and sent to the remote UE (step 15), while all DL data delivered from the CN to the target gNB are sent to the remote UE (step 21). Thus, the handover/path switch procedure can be lossless with respect to DL data sent by the remote UE. Accordingly, the procedure may be seen to provide service continuity.

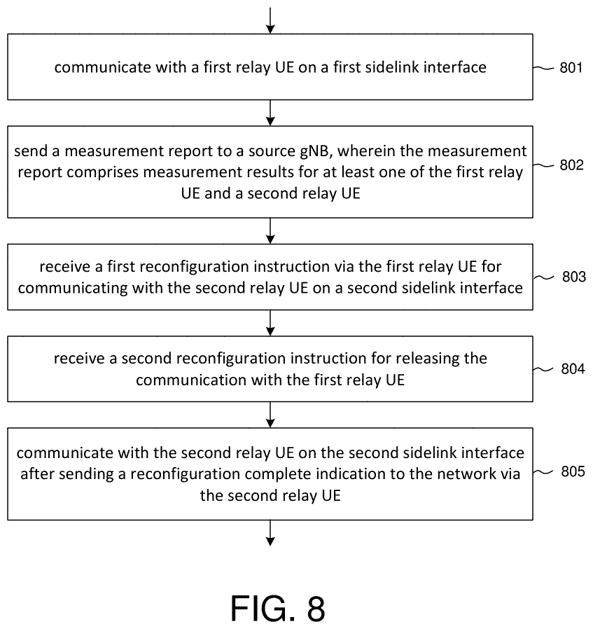

FIG. 8 is a flow chart of a method of indirect-to-indirect path switch from a remote UE perspective in accordance with one novel aspect. In step 801, a remote UE communicates with a first relay UE on a first sidelink interface. In step 802, the remote UE sends a measurement report to a source gNB, wherein the measurement report comprises measurement results for at least one of the first relay UE and a second relay UE. In step 803, the remote UE receives a first reconfiguration instruction via the first relay UE for communicating with the second relay UE on a second sidelink interface. In step 804, the remote UE receives a second reconfiguration instruction for releasing the communication with the first relay UE. In step 805, the remote UE communicates with the second relay UE on the second sidelink interface after sending a reconfiguration complete indication to the network via the second relay UE.

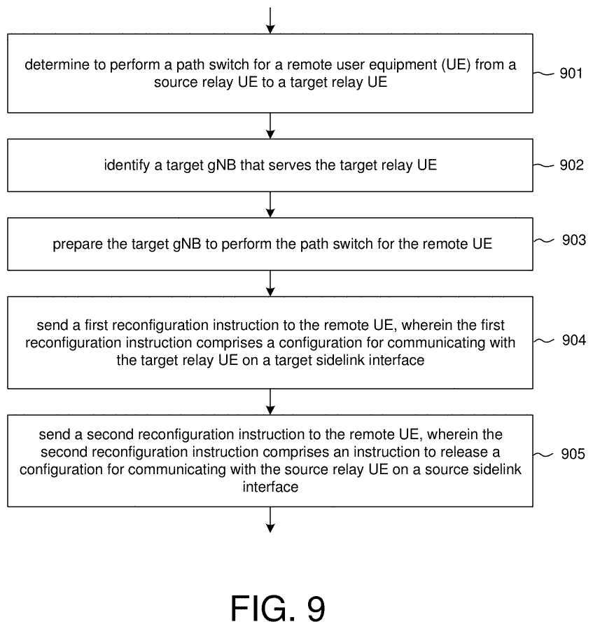

FIG. 9 is a flow chart of a method of indirect-to-indirect path switch from a source gNB perspective in accordance with one novel aspect. In step 901, a source gNB determines to perform a path switch for a remote user equipment (UE) from a source relay UE to a target relay UE. In step 902, the source gNB identifies a target gNB that serves the target relay UE. In step 903, the source gNB prepares the target gNB to perform the path switch for the remote UE. In step 904, the source gNB sends a first reconfiguration instruction to the remote UE, wherein the first reconfiguration instruction comprises a configuration for communicating with the target relay UE on a target sidelink interface. In step 905, the source gNB sends a second reconfiguration instruction to the remote UE, wherein the second reconfiguration instruction comprises an instruction to release a configuration for communicating with the source relay UE on a source sidelink interface.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method performed by a remote user equipment (UE) in a mobile communication network, comprising:
communicating with a first relay UE on a first sidelink interface;
sending a measurement report to a source gNB, wherein the measurement report comprises measurement results for at least one of the first relay UE and a second relay UE;
receiving a first reconfiguration instruction via the first relay UE for communicating with the second relay UE on a second sidelink interface;
receiving a second reconfiguration instruction for releasing the communication with the first relay UE; and
communicating with the second relay UE on the second sidelink interface after sending a reconfiguration complete indication to the network via the second relay UE.

2. The method of claim 1, wherein the first reconfiguration and the second reconfiguration instructions are contained in a single reconfiguration message.

3. The method of claim 1, further comprising:
establishing a second link with the second relay UE on the second sidelink interface based on the first reconfiguration instruction; and
releasing a first link with the first relay UE on the first sidelink interface based on the second reconfiguration instruction.

4. The method of claim 1, wherein the measurement report is triggered based on an event that is conditioned on a measured quantity of signals from at least one of the first and the second relay UEs.

5. The method of claim 4, wherein the measured quantity is a measurement of signal strength or signal quality.

6. The method of claim 4, wherein the event conditions comprise the measured quantity of signals from the first relay UE being below a first threshold.

7. The method of claim 4, wherein the event conditions comprise the measured quantity of signals from the second relay UE being above a second threshold.

8. The method of claim 4, wherein the event conditions comprise the measured quantity of signals from the second relay UE exceeding the measured quantity of signals from the first relay UE by a threshold.

9. The method of claim 1, wherein the first relay UE and the second relay UE are served by the same source gNB.

10. The method of claim 1, wherein the remote UE receives the first reconfiguration message from the source gNB that serves the first relay UE, and wherein the remote UE sends the reconfiguration complete indication to a target gNB that serves the second relay UE.

11. A method performed by a source base station (gNB), comprising:
determining to perform a path switch for a remote user equipment (UE) from a source relay UE to a target relay UE;
identifying a target gNB that serves the target relay UE;
preparing the target gNB for performing the path switch for the remote UE;
sending a first reconfiguration instruction to the remote UE, wherein the first reconfiguration instruction comprises a configuration for communicating with the target relay UE on a target sidelink interface; and
sending a second reconfiguration instruction to the remote UE, wherein the second reconfiguration instruction comprises an instruction to release a configuration for communicating with the source relay UE on a source sidelink interface.

12. The method of claim 11, wherein the first reconfiguration and the second reconfiguration instructions are contained in a single reconfiguration message.

13. The method of claim 11, wherein the source gNB and the target gNB are the same base station.

14. The method of claim 13, further comprising:
sending, prior to the sending of the first reconfiguration instruction, a paging message to the target relay UE to transition to a connected protocol state.

15. The method of claim 13, further comprising:
sending, prior to the sending of the first reconfiguration instruction, a third reconfiguration instruction to the target relay UE for communicating with the remote UE on the target sidelink interface.

16. The method of claim 11, further comprising:
sending, subsequent to the sending of the second reconfiguration instruction, a fourth reconfiguration instruction to the source relay UE for releasing a configuration for communication with the remote UE on the source sidelink interface.

17. The method of claim 11, further comprising:
sending, to an access and mobility function (AMF), a message requesting an identity of the target gNB;
receiving, from the AMF, a message indicating the identity of the target gNB; and
sending, to the target gNB, a handover preparation message that comprises a request to connect the remote UE with the target relay UE.

18. The method of claim 11, further comprising:
sending, to an access and mobility function (AMF), a message requesting the identity of a third gNB;
receiving, from the AMF, a message indicating the identity of the third gNB;
sending, to the third gNB, a first handover preparation message comprising a request to connect the remote UE with the target relay UE;
receiving, from the third gNB, a handover reject message containing an identity of the second gNB; and
sending, to the second gNB, a second handover preparation message comprising a request to connect the remote UE with the target relay UE.

19. A remote user equipment (UE) in a mobile communication network, comprising:
a sidelink interface that communicates with a first relay UE;
a measurement circuit that provides a measurement report to a source gNB, wherein the measurement report comprises measurement results for at least one of the first relay UE and a second relay UE;
a receiver that receives a first reconfiguration instruction via the first relay UE for communicating with the second relay UE on a second sidelink interface, wherein the receiver also receives a second reconfiguration instruction for releasing the communication with the first relay UE; and
a transmitter that sends a reconfiguration complete indication to the network via the second relay UE, wherein the UE communicates with the second relay UE on the second sidelink interface.

20. The UE of claim 19, wherein the first reconfiguration and the second reconfiguration instructions are contained in a single reconfiguration message.
